(19) United States
(12) Patent Application Publication
(10) Pub. No.: US 2019/0230901 A1
(43) Pub. Date: Aug. 1, 2019

(54) METHOD AND PROGRAM PRODUCT FOR LOCATION TRACKING

(71) Applicants: Janice Mooneyham, Seal Beach, CA (US); Karen Hanover, Seal Beach, CA (US)

(72) Inventors: Janice Mooneyham, Seal Beach, CA (US); Karen Hanover, Seal Beach, CA (US)

(21) Appl. No.: 16/380,200

(22) Filed: Apr. 10, 2019

Related U.S. Application Data
(63) Continuation of application No. 14/286,541, filed on May 23, 2014, now abandoned.

(51) Int. Cl. A01K 11/00; A01K 15/02

(52) U.S. Cl. CPC A01K 11/008; A01K 15/023

(57) ABSTRACT

A system, method and a program product includes configuring a tracking beacon device for associating the tracking beacon device to an entity to be tracked and an owner of the tracking beacon device. The tracking beacon being at least partially implanted into the entity, and the system detects when it is departing a determined boundary. A notification of the escape event is transmitted. The device notifies a monitoring service provider to monitor a signal broadcasted by the tracking beacon and activates a computing device application to receive a communication from the monitoring service provider. The communication at least includes a location for the signal. The tracking beacon is activated to broadcast the signal.

### CROSS-REFERENCE TO RELATED APPLICATIONS

The present continuation patent application claims priority benefit of the U.S. nonprovisional patent application Ser. No. 14/286,541 entitled “Implantable Chip for Pets with GPS Tracking Capabilities” filed 23 May 2014. The contents of this related patent application is incorporated herein by reference for all purposes to the extent that such subject matter is not inconsistent herewith or limiting hereof.

### RELATED CO-PENDING U.S. PATENT APPLICATIONS

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to location tracking. More particularly, certain embodiments of the invention relate to methods for using biocompatible tracking devices.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a tracking system includes a global positioning system (GPS) module and a modem for mobile communications both attached to a pet, or other trackee, and a virtual fence, which includes a base station sending a signal to a certain range and a receiver attached to the pet and receiving the signal sent by a base station when the receiver is within the range of the base station.

By way of educational background, another aspect of the prior art generally useful to be aware of is that of a kit for monitoring and tracking the location of at least one animal which includes a GPS implant designed to be transplanted subcutaneously into an animal, and capable of communicating spatial information related to the location of the animal.

By way of educational background, another aspect of the prior art generally useful to be aware of is that of an animal tracking system provides for remotely monitoring animal positioning. The biomedical grade implant incorporates a GPS receiver that determines the animal's location.

By way of educational background, another aspect of the prior art generally useful to be aware of is that of an animal tracking system is provided for remotely monitoring animal positioning, the system includes an implant device, a global positioning system, a network, one or more remote servers, and at least one wireless computing device.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary tracking device, in accordance with an embodiment of the present invention;

FIG. 2A illustrates an exemplary tracking device, in accordance with an embodiment of the present invention;

FIG. 2B illustrates an exemplary implementation of a limb stretch based motion energized power generating harness apparatus, in accordance with an embodiment of the present invention;

FIG. 3 illustrates an exemplary tracking system, in accordance with an embodiment of the present invention;

FIG. 4 illustrates an exemplary external charging system, in accordance with an embodiment of the present invention;

FIG. 5 illustrates an exemplary internal charging system, in accordance with an embodiment of the present invention;

FIG. 6 illustrates an exemplary external collar system, in accordance with an embodiment of the present invention;

FIG. 7 illustrates an exemplary mobile tracker, in accordance with an embodiment of the present invention;

FIG. 8 illustrates an exemplary injection device, in accordance with an embodiment of the present invention;

FIG. 9 illustrates exemplary programming blocks, in accordance with an embodiment of the present invention;

FIG. 10 illustrates an exemplary method, in accordance with an embodiment of the present invention;

FIG. 11 illustrates an exemplary method, in accordance with an embodiment of the present invention; and

FIG. 12 is a block diagram depicting an exemplary client/server system which may be used by an exemplary web-enabled/networked embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [”substantially“] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearward most point of the upper or outsole.

Similarly, the term ‘substantially’ is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying, ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. §112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said, “the claims specify that the film is “substantially” eliminated and for the intended purpose, it is believed that the slight portion of the film which may remain is negligible. We are of the view, therefore, that the claims may be regarded as sufficiently accurate.” Similarly, in re Hutchison, 104 F.2d 829, 42 USPQ 90, 93 (C.C.P.A. 1939) the court said, “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be bed in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s),which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers),examples of an “end user” may include, without limitation, a “consumer,” “buyer”, “customer”, “purchaser”, “shopper”, “enjoyer”, “viewer”, or individual person or non-human thing benefiting in any way, directly or indirectly, from use of, or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party,” “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C..sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the presently disclosed and claimed subject matter may include the use of either of the other two terms. Thus, in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java.™., Jini.™., C, C++, Smalltalk, Perl, UNIX Shell, Visual Basic or Visual Basic Script, Virtual Reality Markup Language (VRML), ColdFusion.™. or other compilers, assemblers, interpreters or other computer languages or platforms.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links, and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, removable media, flash memory, a “memory stick”, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, Firefox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM.®. MQSeries.®. technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Additionally, the phrase “configured to” or “operable for” can include generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

In some embodiments of the present invention, and variation thereof, an implantable, biocompatible internal portion of a tracking beacon system is provided according to the teachings of the present invention, which may be inserted or implanted into a pet (or human). In some embodiments, the pet chip may be inserted at home by an owner or implanted by a veterinarian. Preferred implanted embodiments of the microchip may be powered by any known techniques of powering implanted electronics devices, some of which are exemplified in more detail below.

In some embodiments, the chip may give off “beacons” at intervals pre-established to be detected by a virtual fence. In some embodiments, a virtual fence may be created where the boundaries of this fence may be altered and/or changed as desired. In some embodiments, the virtual fence may search for the tracking beacon system at predetermined intervals. In some embodiments, if the tracking beacon system is located as being within the virtual fence, nothing happens. In some embodiments, if the tracking beacon system may not be detected within the established boundary, a notification may be sent to enabled devices. In some embodiments, software may sync up the virtual fence with the tracking beacon system. In some embodiments, the proprietary software may prompt the user's notification settings in case the tracking beacon system goes outside of the boundary. In some embodiments, the user may be asked to respond to the notification by causing the tracking beacon system to power “on.” In some embodiments, if the pet is moving such as, but not limited to, running, flying etc., the tracking beacon system may be substantially charged via piezo electrical activity from muscle movement. In some embodiments, if the user does not enable the device (e.g. cell phone turned off or signal unavailable), the software may contact the next notification setting such as, but not limited to, family member, neighbor, friend, animal control, etc. In some embodiments, the tracking beacon system may communicate through cell towers. In some embodiments, this device may also be used for, but not limited to, horses, birds, marine life, mammals including cattle tracking. In some embodiments, it may also be used in luggage, inserted in bicycle frames to prevent theft and/or track stolen bikes. In some embodiments, it may also be used in humans to, but not limited to, prevent kidnapping/track lost or stolen children or to replace ankle monitors such as, but not limited to, in the case of offenders required to wear tracking devices for life and even in soldiers in case of capture.

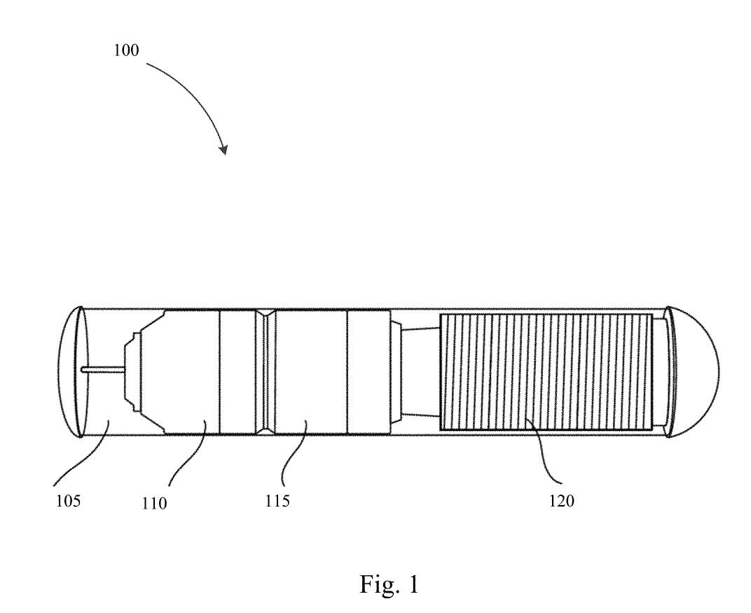

FIG. 1 illustrates an exemplary tracking beacon device, in accordance with an embodiment of the present invention. In the present embodiment, an implantable tracking beacon device 100 may include a capsule 105, a computing module 110, a power transducer 115 for receiving power for an energy storage means such as, but not limited to, a battery or super-capacitor; a communications module 120, to provide the needed communications that enable external tracking assets to at least generally locate or track the pet's position. An antenna (not shown) may be configured into, onto, or within capsule 105 as needed for the particular type of communication mode(s) employed by communications module 120.

Communications module 120 may be configured as a transmitter, receiver, or as a transceiver depending upon the needs of particular application. By way of example, and not limitation, if tracking beacon device 100 is to be non-interactive communications module 120 may be configured as a transmit only module to simply transmit a beacon signal for external tracking assets to detect, or if, instead more rich interactive behavior is desired communications module 120 may be configured as a transceiver to receive signals from the environment, which may control the behavior of tracking beacon device 100. By way of example, and not limitation, in some alternative embodiments, communications module 120 may be configured with an FM and/or AM RF radio transceiver and a Radio Data System chipset (RDS)and computing module 110 may be configured to control communications module 120 to scan the strong (i.e., nearby) radio stations and store the strongest one(s) whereby computing module 110 may be configured with a short distress message (e.g., without limitation, a message up to 128 characters including alert and contact info like “Lost black German Sheppard nearby you—PLEASE CALL 555-555-1212 to report, will pay finder's fee.”) and employ the RDS and RF transmitter in communications module 120 to periodically broadcast the RDS message within a certain radius in the hopes that a passer-by good Samaritan in that radius with an RDS equipped radio notices the message and makes the call of a sighting or at least notifying the pet owner the location the pet was last detected. Other alternative modes for communications module 120 include being configured with capabilities to communicate with external communication systems such as, but not limited to, cell phone systems, WIFI systems, Bluetooth, and GPS systems. However, it is contemplated that size and power limitations will often dictate which mode is best for the needs of particular application. The foregoing RDS example may be similarly adapted to work with other device communication modes. By way of example, and not limitation, in alternative interactive embodiments configured with WiFi or Bluetooth capabilities, computing module 110 may be configured to control communications module 120 to scan for nearby Bluetooth and/or WiFi devices and attempt to similarly transmit the distress message; e.g., for Bluetooth, the tracking beacon device may instead attempt to pair with nearby cell phone(s) to send the distress message and to increase the chances of the stranger accepting the pairing, maybe set the Bluetooth name as something like “LostDogHelp”; and for WiFi, the tracking beacon device may instead attempt to log onto nearby public Internet networks and either attempt to send a distress email to the owner (e.g., having the IP address of the WiFi's ISP for location tracking) or at least broadcast a distress WiFi device ID with something like “LostDog-<CODE>”(“CODE” being a pet ID code) whereby all regional ISPs might be contracted to look out for such a WiFi device name and automatically report when detected. In some embodiments this may be done like an “Amber Alert” done by radio stations except for all WiFi network devices. In some alternative embodiments, an app may provided for, configured into, mobile devices in the region of the pet to carryout out a crowd-sourcing search for the lost pet and wherein the app could be triggered by the base system and/or the pet owner to do the foregoing crowd-sourcing device name lookout and reporting. When the Bluetooth pairing or WiFi communications modes are done with a cell phone it may also be possible to get GPS or cell-tower triangulated location of the phone, and thereby the general area the pet is located, possibly as at least within ˜50 m in urban areas. Those skilled in the Art, in light of the teachings of the present invention, will readily recognize a wide variety of suitable means and methods to configure tracking beacon device 100 and external networked systems to achieve reporting of at least one, time stamped general location of the pet so that search parties may narrow their search to greatly increase, if not assure, the chances of finding their lost pet.

In the present embodiment, capsule 105 is a suitable enclosure for tracking beacon device 100, which may be comprised of a biocompatible material such as, but not limited to, a biocompatible glass capsule or a cap made of polypropylene polymer to keep the electronics/chip system module from moving around once it's inside the animal. In a non-limiting example, the polymer may work by encouraging connective tissue and other kinds of cells to form around the capsule to hold it in place. Computing module 110 maybe any suitable computational device which carries out the logic, state machine, and/or algorithms as needed by the particular application in light of the teachings of the present invention, such as, but not limited to, a microchip, system on a chip, gate array logic (GAL), PAL, logic gates, etc. For WiFi or Cell phone communications applications, those skilled in the art will know that transceiver system 225 and an antenna system 230 may be a commercially available 100 mW wireless transmitter Module that are commonly less than 1″ long, 0.25″ wide, and ⅛″ thick, with common frequencies such as, but not limited to, AM, FM, 900 MHz, 1.8 MHz, and/or 2.4 GHz. In some alternate embodiments, towards minimizing system complexity and power draw, transceiver system 225 may be configured for Cell phone communications applications employing simple Frequency division multiplexing such that the cell phone service provider (SP) may designate a certain frequency channel, by way of example, and not limitation, 824.04 MHz, for detecting transmissions by tracking beacon device 100 and Computing module 110 may be configured to send out via transceiver system 225 carrier frequency pulsing to communicate lost pet identification information using known techniques such as, but not limited to, frequency shift keying, or Morse code, etc. In such approaches, the SP may provide this base station RF/software detection function as a contracted service rendered to the pet owner. Those skilled in the Art, in light of the teachings of the present invention, will readily recognize a multiplicity of suitable, practical, and optimal techniques for SP to detect and receive identifying information from tracking beacon device 100. In the present embodiment, by virtue of the power output of transceiver system 225 being so low, the SP may more easily localize tracking beacon device 100 within a relatively small radius of the cell phone tower in a bad case, and, using the shift keying (or some other time path synchronizing method) to synchronize upon, be able to triangulate general location between nearby towers in the more ideal case.

In some alternative embodiments, inertial navigations techniques may be employed to obtain reasonably usable estimates of location during blackouts of the foregoing more accurate approaches. However, it is contemplated that due to the drift errors inherent in any dead reckoning navigation system, some kind recalibration method (e.g., without limitation, using periodic landmarks to reset coordinate locations) would be needed beyond a certain distance of travel, esp. if the motion was more zig-zag than linear. Some emerging technologies that may help accuracy/robustness of the foregoing pet tracking techniques of the present invention may include atomic scale sensing of the Earth's magnetic field acceleration and position to help determine geo-locations without GPS or local communication networks, such as the DARPA-funded chip-scale combinatorial atomic navigation, or C-SCAN, and Quantum Assisted Sensing (QuASAR) initiatives.

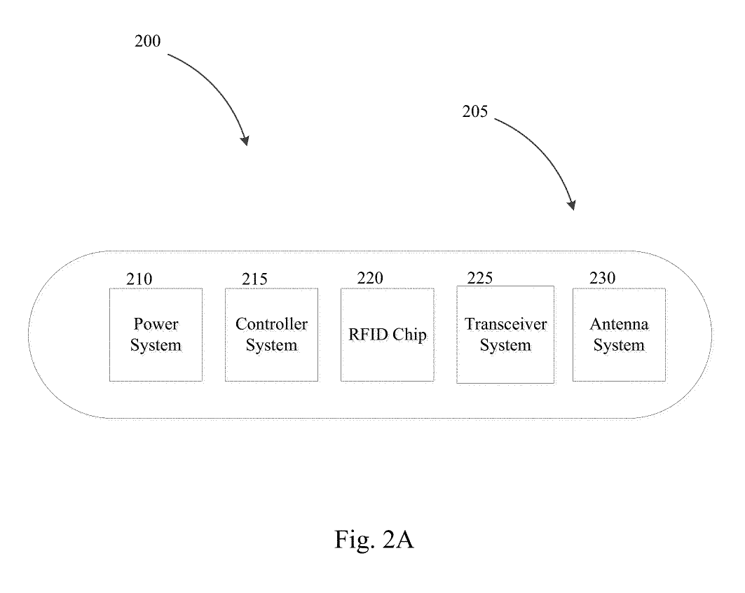

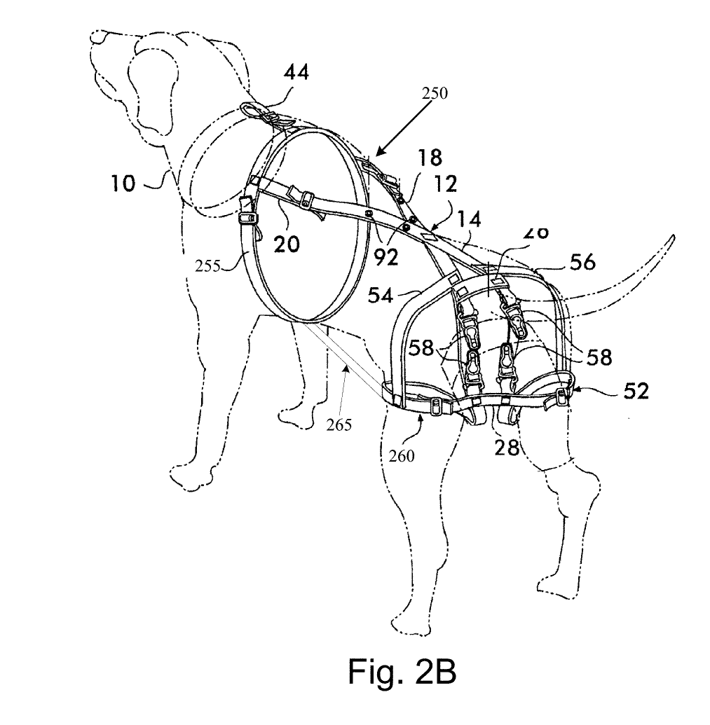

FIG. 2A illustrates an exemplary tracking device, in accordance with an embodiment of the present invention. In the present embodiment, an implantable tracking beacon device 200 may include a capsule 205, a power system 210, a controller system 215, an optional RFID chip 220, a transceiver system 225, and an antenna system 230. In the present embodiment, power system 210 may include, but not limited to, a primary and/or rechargeable battery and/or a power generating means, and/or a power storage means. Moreover, power system 210 may, without limitation, be configured to completely internal to the body, be completely external to the body, or partially internal and external. In some embodiments, the power generating means may supply power to recharge the battery using means and/or power storage means. The power generating means may be any suitable technology approach that performs as needed depending on the particular configuration and behavior of the tracking beacon device for the desired application. When any portion of power system 210 is configured to be external to the body, power may be transferred to the internal the internal portion by way of any suitable technology approach that performs as needed depending on the particular configuration and behavior of the tracking beacon device for the desired application; such as, without limitation an induction coupling device to an external power source, a direct connection via a skin surface embedded fastened electrode, microwaves, pressure waves, etc. For instance, in some alternative embodiments, power may be transferred to the internal the internal portion by way of conventional transcutaneous ultrasonic energy transferring approaches to power to implanted devices such as, without limitation, the technique of S Ozeri (et. al.) (“Ultrasonic transcutaneous energy transfer for powering implanted devices, S OZERI, D SHMILOVITZ—Ultrasonics, 2010—Elsevier) where they provide a method for energizing implanted devices at power level up to a few 100 m. Their transducers consisted of PZT plane discs of 15 mm diameter and 1.3 mm thick acoustic matching layer made of graphite. They reported attaining 88.5% power transfer efficiency. Yet other suitable means of acoustic power transfer may include those covered by H Basaeri (et. al.) in “A review of acoustic power transfer for bio-medical implants” H Basaeri, D B Christensen, S Roundy—Smart Materials and Structures, 2016—par.nsf.gov. Yet other conventional means of transferring power to any internal portion of the tracking beacon device are covered by A Ben Amar et. al. (A Ben Amar, A B Kouki, H Cao—“Power approaches for implantable medical devices” Sensors, 2015—espace2.etsmtl.ca, Logo. La vitrine de diffusion des publications et contributions des chercheurs de l'ÉTS. RECHERCHER.).

In some embodiments, the power generating means may include any suitable conventional power harvesting device, or any combinations thereof, such as, without limitation, a motion energized power generating device, a micro-generator, a thermo electric power generating device, solar photocell power generating device, a chemical power generating device, and/or an enzymatic power generating device. In some embodiments the motion energized power generating device may include, without limitation, a motion activated flywheel engaging a generator, and/or a motion energized piezo electric or elastomer element.

Those skilled in the art will readily recognize, in light of the teachings of the present invention, that the power generating and/or energy/power storage devices may be configured in any of a multiplicity of suitable ways depending upon the needs of the particular application and available technologies to balance the numerous design vs cost vs performance trade-offs, wherein, without limitation, the power generating and/or energy/power storage devices may be partially or fully internal or external to the animal, and/or directly or indirectly engaged with the animal, and/or (semi)permanent or removable.

Suitable chemical power generating device may include, without limitation, techniques of in-vivo enzymatic fuel cells deriving electrical power directly from the blood such as, but not limited to, that achieved by Dmitry Pankratov et. al. in re Ex vivo electric power generation in human blood using an enzymatic fuel cell in a vein replica, Royal Society of Chemistry, RSC Advances, 2016, Volume 6, ISSN 2046-2069, Pages 70215-70220.

Suitable thermoelectric energy harvester for power generating may include, without limitation, techniques using non-toxic alloys of liquid metal (e.g., gallium and indium-EGaIn) to connect conventional rigid thermoelectric devices for flexible wearable application such as, but not limited to, that employed by Francisco Suarez et. al. “Flexible thermoelectric generator using bulk legs and liquid metal interconnects for wearable electronics”. Applied Energy, 2017; 202: 736, or wearable thermoelectric generators, such as, without limitation, that may be printed on ordinary paper and fabrics to be integrated into clothing as exemplified by Kiarash Gordiz, et. Al., “Interconnect patterns for printed organic thermoelectric devices with large fill factors.” Journal of Applied Physics, 2017; 122 (12), and thermoelectric screen printing techniques such as, but not limited to, that employed by Tony Varghese, et. al. (“High-performance and flexible thermoelectric films by screen printing solution-processed nanoplate crystals.” Scientific Reports, 2016; 6: 33135 DOI: 10.1038/srep33135), which can generate thermoelectric power at 2-3 cents per watt. Such methods currently may be scaled up to harvest power in the milliwatt range. In some embodiments, while the implantable tracking beacon device is in the “stand-by” or “off” mode the low power generated may trickle charge the battery and/or a power storage means.

Suitable motion energized harvesting device for power generating may include, without limitation, conventional piezo-electric devices strategically located on the pet or accessories worn thereby, or techniques using stretchable materials that may be actuated by limb/muscle motion, such as, but not limited to, those that employ carbon nanotube yarns similar to that of Shi Hyeong Kim, et. al. (“Harvesting electrical energy from carbon nanotube yarn twist.” Science, 25 Aug. 2017: Vol. 357, Issue 6353, pp. 773-778 DOI: 10.1126/science.aam8771). The carbon nanotube yarns of Kim et. al. can generate 250 watts per kilogram of peak electrical power when stretching the coiled twistron yarns 30 times a second. Their carbon nanotube yarns are so energetic that a twistron yarn weighing less than a housefly could power a small LED, which lit up each time the yarn was stretched. They have demonstrated producing over a hundred times higher electrical power per weight when stretched compared to prior weave-able fibers. As such, harvesting electrical energy from the pet's limb motion is one practical strategy for recharging the batteries and/or power storage elements, if not eliminating the need for batteries all together in some applications.

Suitable power storage device, without limitation, may include super capacitors, in some embodiments including those that are wearable that may be integrated into pet accessories worn thereby, such as, but not limited to, those that implant conductive and charge storage materials into accessories or fabrics worn by the pet to create large surface areas that function as current collectors and nanoparticle reservoirs for the capacitor electrodes as achieved by Yongmin Ko et. al. (“Flexible supercapacitor electrodes based on real metal-like cellulose papers” Nature Communications, 2017; 8 (1) DOI: 10.1038/s41467-017-00550-3).

In the present embodiment, controller system 215 may include, without limitation, a low power processor, firmware/software, and data storage. Transceiver system 225 may include, without limitation a receiver system and a low power transmitter system. In some embodiments, transceiver system may be operated to communicate with local systems such as, but not limited to, cell phone systems, WIFI systems, and Bluetooth systems. In many embodiments, the low power transmitter may be designed to minimize power draw from the battery system using known methods such as, but not limited to, limiting range of coverage or to pulse short duration high power signals (e.g., in beacon applications). In some alternate embodiments, tracking beacon device 200 may be characterized as belonging to a group of Internet of Things (IOT). In these embodiments, tracking beacon device 200 may utilize very low power radios designed for IOT devices such as, but not limited to, sensors. In the present embodiment, antenna system 230 may be optimized for low power communications with the local systems. In some alternate embodiments, tracking beacon device 200 may include a passive RFID chip 220. In a non-limiting example, if the transceiver system 225 fails to communicate, RFID chip 220 may be read by a standard chip reader. In some embodiments, data contained in the chip may be at least a part of the data in the data storage.

FIG. 2B illustrates an exemplary implementation of a limb stretch based motion energized power generating harness apparatus, in accordance with an embodiment of the present invention. In the present embodiment, an exterior harness 250 is configured to be worn by the pet and may have a front attachment member 255 and a rear leg attachment member 260 for joining a motion power generating element 265 there between. While the left side is shown, the right-side leg may have a similar configuration. Of course, exterior harness 250 may, in alternative embodiments, instead be any suitable design approach that will be readily apparent to those skilled in the art, in light of the teachings of present invention, which provides for the attachment points to achieve the cyclical stretching of motion power generating element 265. Motion power generating element 265 may be any suitable conventional devices which generate electricity when mechanically stretched, such as, without limitation, the foregoing examples. In the present embodiment, as the pet walks or runs, motion power generating element 265 is repeatedly mechanically stretched and relaxed to generate electrical power. By way of example, and not limitation, motion power generating element 265 may be a scaled-up version of the carbon nanotube yarns of Shi Hyeong Kim, et. al., suitably sized to generate enough power assuming normal activity of the pet, which power may, without limitation, be stored instantaneously accumulated in the power storage device (e.g., without limitation, an external super capacitor) and then more slowly provided to the rechargeable battery at a rate which maximizes battery longevity. To generate more stretch, thus more power per stroke, rear leg attachment member 260 may be configured to be more towards the pet's knee and/or front attachment member 255 more forward (e.g., closer to front shoulder), to the extent comfortable for the pet. Indeed, in some applications, the present embodiment may be considered as a healthy lifestyle improvement for the pet by giving the pet more exercise while walking/running around, in a conceptually similar manner as human choosing to wear some ankle/wrist weights to get more fit/healthy while doing normal daily activities.

In some alternative embodiments, a body vest garment (not shown) may be employed (either configured onto a harness system or stand-alone like a common pet warming vest). In such embodiments, the body vest garment may, without limitation, be made of super capacitor fabrics and possibly lined with flexibly thin film lithium ion polymer/prismatic cells. In some alternative embodiments, including of the body vest garment embodiment, a wearable solar photocell power generating device may be configured onto exposed areas to collect solar radiation while outdoors and thereby contribute to recharging the power generating and/or energy/power storage devices.

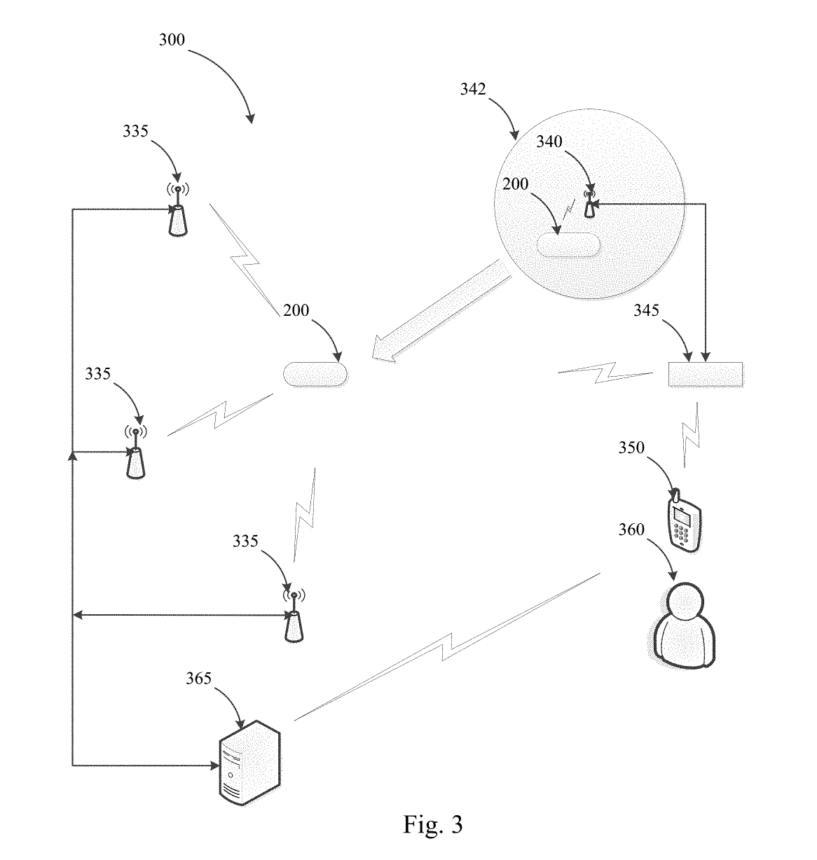

FIG. 3 illustrates an exemplary tracking system, in accordance with an embodiment of the present invention. In the present embodiment, a system 300 may include an implantable tracking beacon device 200, a virtual fence or boundary 342, a boundary controller 345, one or more local systems 335, at least one remote communications server 365, and a mobile computing device 350. Mobile computing device 350 may be any device capable of communicating with networks such as, but not limed to, cell phone and WIFI. Mobile computing device 350 may include, but not limited to, laptops, tablets, smartphones, smartwatches, etc. In the present embodiment, tracking beacon device 200 may be initially established within boundary 342. In some embodiments, boundary 342, may be a wired or wireless boundary. In the present embodiment, when tracking beacon device 200 is within boundary 342 tracking beacon device 200 may be considered to be in an “off” state. During this time, power system 210 maybe receiving power to maintain a charge on the battery. In this state tracking beacon device 200 may be in a power saving mode and emitting a short low power identification burst or chirp at a slow periodic rate. In some embodiments, this rate may be in minutes. In other embodiments, the rate may be shorter or longer. In some alternate embodiments, the rate may be user programmable. In the present embodiment, the chirp may be received by a receiver unit 340 and communicated to controller 345. In many embodiments, controller 345 may determine if tracking beacon device 200 remains within boundary 342. In the present embodiment, controller 345 may determine that tracking beacon device 200 is outside of boundary 342 if one or more expected chirps have not been received. In other alternative embodiments, multiple receiver units 340 may be employed and controller 345 may make a location determination by comparing signals from the receiver units. In the present embodiment, controller 345 may prompt a user's notification settings in case tracking beacon device 200 goes outside of boundary 342. In some embodiments, a user 360 may be asked to respond to the notification by causing tracking beacon device 200 to power “on.” In some embodiments, if the user does not enable the device (e.g. cell phone turned off or signal unavailable), the software may contact the next notification setting such as, but not limited to, family member, neighbor, friend, animal control, etc. In the present embodiment, when tracking beacon device 200 is in the “on” state, tracking beacon device 200 may emit longer chirps to include for example, but not limited to, contact information for the user. In some embodiments, tracking beacon device 200 may increase power and/or rate of chirping. In the present embodiment, user 360 may use mobile computing device 350 to communicate a turn-on message such as, but not limited to, a Short Message Service (SMS) to tracking beacon device 200. In some embodiments, user 360 may instruct controller 345 to message tracking beacon device 200 to power “on”. In some alternate embodiments, controller 345 may message tracking beacon device 200 to power “on” prior to sending notifications.

In the present embodiment, when tracking beacon device 200 is in the “on” state, tracking beacon device 200 may emit chirps that one or more local systems 335 may receive. The chirps may include, but not limited to, identification (ID) information and be recognizable by local systems 335. In some embodiments, local systems 335 may include, but not limited to, cellular platforms operated by a Service Provider (SP). In some embodiments, the SP may have contracted to recognize the chirps and send a notification from system 365 to the owner's mobile computing device 350. In some embodiments, the SP may determine the location of tracking beacon device 200 and relay this information in the notification. The SP may have numerous methods of estimating the location without utilizing GPS such as, but not limited to, triangulation, directionality, distance estimation, etc. In some alternate embodiments, the SP may provide essentially continuous notifications or messages updating the location during the time chirps are detected. In some alternate embodiments, local systems 335 may be operated by an Internet Service Provider(ISP) as hot spots. In some embodiments, the ISP may have contracted to recognize the chirps and send a notification from system 365 to the owner's mobile computing device 350. In some embodiments, the ISP may determine the location of tracking beacon device 200 and relay this information in the notification. The ISP may have numerous methods of estimating the location without utilizing GPS such as, but not limited to, location of hot spot, directionality, distance estimation, etc. In some other embodiments, local systems 335 may include Bluetooth enabled smart devices and receive a pairing request from tracking beacon device 200. In some embodiments, the Bluetooth enabled smart devices may communicate the pairing to a SP or ISP for notification to mobile computing device 350. In some other embodiments, an owner of the Bluetooth enabled smart devices may be requested, as a Good Samaritan to directly contact the owner of tracking beacon device 200. In some other embodiments, local systems 335 may include mobile computing devices in which the owners have installed apps to recognize the chirps and directly communicate to the owner's mobile computing device 350. In some alternate embodiments, owners with installed apps may be able to take a picture of a lost pet and attach the picture to the notification sent to the owner of the pet.

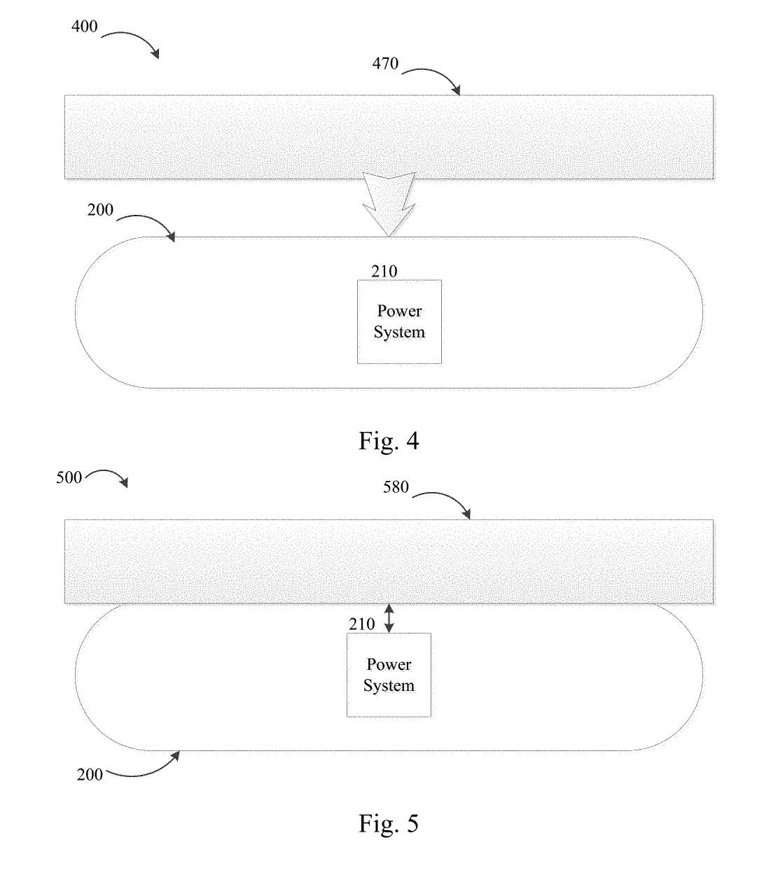

FIG. 4 illustrates an exemplary external charging system, in accordance with an embodiment of the present invention. In the present embodiment, system 400 may include an external power source 470, and tracking beacon device 200 with power system 210. In the present embodiment, external power source 470 may include a power generating means locatable externally to tracking beacon device 200. In a non-limiting example, external power source 470 may be configured as a collar to be worn on pet with tracking beacon device 200 positioned below the collar. In some embodiments, the power generating means may be coupled to power system 210 by a connection means such as, but not limited to, induction coupling, RF coupling, etc. In some embodiments, power system 210 may recharge an internal battery from power received from external power source 470. In some embodiments, power generating means may include, but not limited to, a motion activated generator, solar cells, etc. In some alternate embodiments, external power source 470 may include a rechargeable battery to store excessive charge.

FIG. 5 illustrates an exemplary internal charging system, in accordance with an embodiment of the present invention. In the present embodiment, system 500 may include an internal power source 580, and tracking beacon device 200 with power system 210. In the present embodiment, internal power source 580 may include a power generating means coupled to power system 210. The power generating means may include, without limitation, piezo-electrical activity from muscle movement, chemical, and/or temperature. In the present embodiment, power from the power generating means may be coupled directly to power system 210 for charging the internal battery.

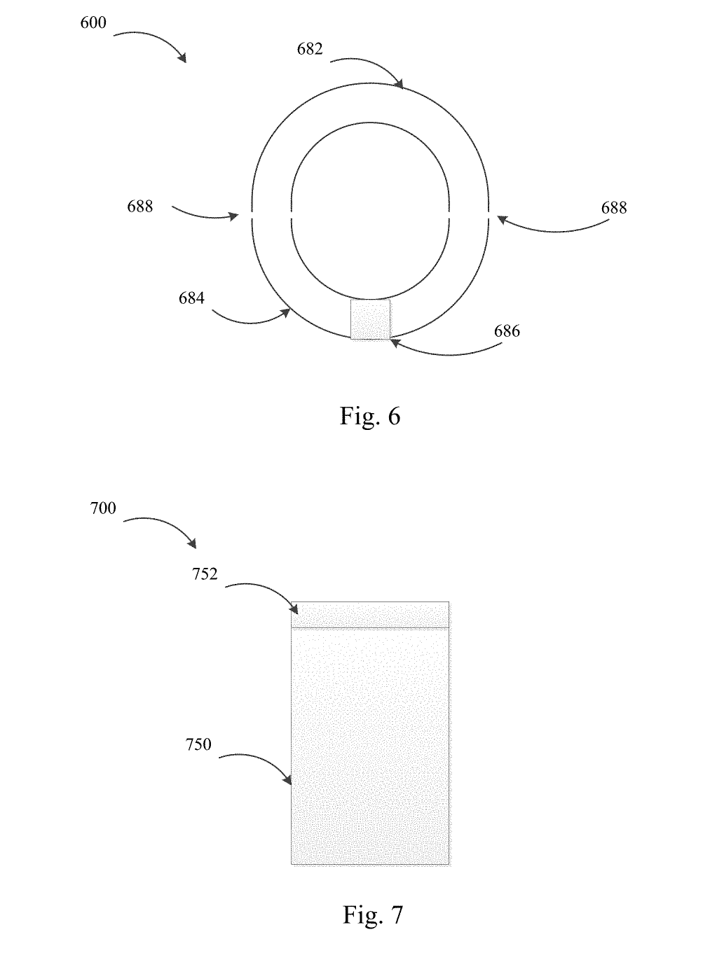

FIG. 6 illustrates an exemplary external collar system, in accordance with an embodiment of the present invention. In the present embodiment, collar system 600 may include an upper portion 682, a lower portion 684, breakaway portions 688, and ID portion 686. In the present embodiment, upper portion 682 and lower portion 684 may be joined together by breakaway portions 688. In the present embodiment, breakaway portions 688 may be constructed to separate the upper portion 682 from the lower portion 684 when an amount of force is applied to collar system 600. In a non-limiting example, when the collar is used on a pet and the collar becomes snagged on a surrounding object, the collar may breakaway to mitigate harm to the pet. In the present embodiment, collar system 600 may include the external power source 470 or FIG. 4. In some alternate embodiments, ID portion 686 may include indicia indicating the pet's name and owner information. In some alternate embodiments, ID portion 686 may provide weight to collar system to help maintain positioning of external power source 470 relative to embedded tracking beacon device 200. In some alternate embodiments, ID portion 686 may include a tracking beacon device 200 that may be activated to assist in locating a detached collar.

FIG. 7 illustrates an exemplary mobile tracker, in accordance with an embodiment of the present invention. In the present embodiment, mobile tracker 700 may include mobile computing device 750 and a signal tracking device 752. In the present embodiment, tracking device 752 may include one or more antennas and radio devices tuned to receive signal chirps from tracking beacon device 200. Mobile computing device 750 may include, but not limited to, laptops, tablets, smartphones, etc. In the present embodiment, mobile tracking device 752 may communicate with mobile computing device 750 via an available external port on mobile computing device 750 such a, but not limited to, a USB port. In other alternative embodiments, RF technologies such as Bluetooth or WIFI may be utilized. In the present embodiment, a custom app on mobile computing device 750 may operate tracking device 752 and display tracking beacon device 200 location and/or directionality from mobile computing device 750. In some alternate embodiments, mobile computing device 750 may display a street map with the location information received from mobile tracking device 752. In some other alternate embodiments, mobile computing device 750 may display a street map with the location information received from mobile tracking device 752 and location information received from system 300. In the present embodiment, tracking device 752 may be attached to mobile computing device 750 on any side that is convenient. In some other alternate embodiments, tracking device 752 may not be attached and be handheld.

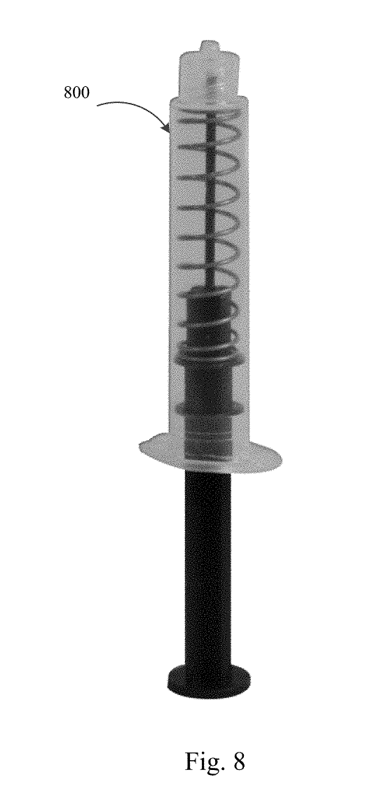

FIG. 8 illustrates an exemplary injection device, in accordance with an embodiment of the present invention. In the present embodiment, injection device 800 may be used to inject tracking beacon device 200 beneath a skin. In other embodiments, injection device 800 may have different forms that perform the service.

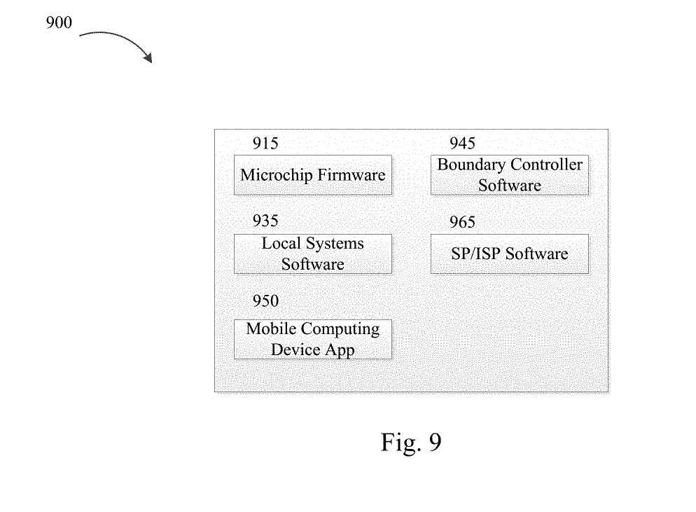

FIG. 9 illustrates exemplary programming blocks, in accordance with an embodiment of the present invention. In the present embodiment, system 900 may at least include a microchip firmware 915, a boundary controller software 945, a local systems software 935, a SP/ISP software 965, and a mobile computing device app 950. In the present embodiment, custom programming blocks of system 900 may be used for implementation of system 300. Other embodiments may use fewer or more programming blocks.

In any of the foregoing embodiment it may be important or desirable to be able to form circuits (e.g., without limitation, interconnects, RFID tags, energy generation/storage means, controllers, sensors, etc.), wherein conventional methods of printing functional electronics directly into the pet's skin (e.g., without limitation, like tattoos) may be employed by the systems designer if desirable in some alternative embodiments, using techniques such as, but not limited to, that of Shuang Guo (et. al.) [“3D Printed Stretchable Tactile Sensors”/Guo, Shuang Zhuang; Qiu, Kaiyan; Meng, Fanben; Park, Sung Hyun; Mcalpine, Michael C.; In: Advanced Materials, Vol. 29, No. 27, 1701218, 07.2017.]

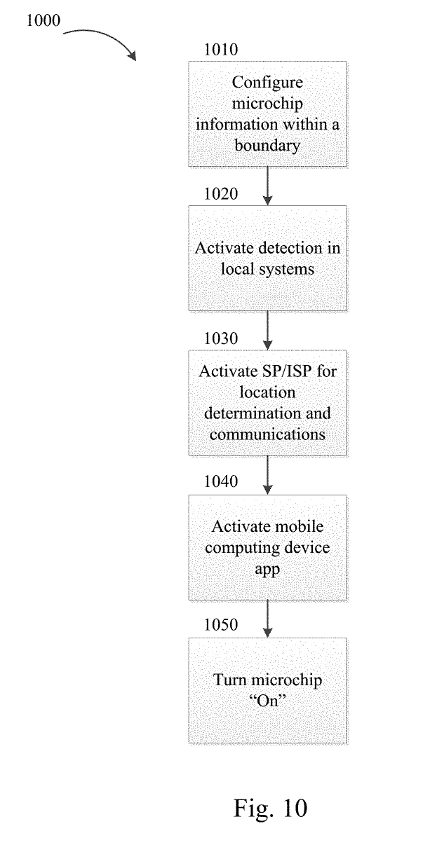

FIG. 10 illustrates an exemplary method, in accordance with an embodiment of the present invention. In the present embodiment, method 1000 may start at a step 1010 where tracking beacon device 200 may be configured for use within boundary 342. In some embodiments, firmware for tracking beacon device 200 may be updated to include for example, but not limited to, ID, contact information for the user, and operating parameters. In some embodiments, controller 345 in combination with mobile computing device 350 may be utilized to update the firmware. In a step 1020 detection software may be needed and activated in local systems 335. In some embodiments, an agreement or contract with the SP/ISP that operates the local systems 335 may be required. In a step 1030 location determination and communications information for user 360 may be activated at the SP/ISP. Activation may require custom software and an agreement or contract with the SP/ISP. In a step 1040 a custom app may be need on the user's mobile computing device 350. In some embodiments, the app may be needed to be activated by the user. In other alternate embodiments, the instalment of the app may active the app to run in a background mode. In a step 1050 tracking beacon device 200 may be turned “On” to chirp to local system 335 when controller 345 detects that tracking beacon device 200 has left boundary 342. In some embodiments, a user 360 may be asked to respond to the notification by causing tracking beacon device 200 to power “on.” In some embodiments, if the user does not enable the device (e.g. cell phone turned off or signal unavailable), the software may contact the next notification setting such as, but not limited to, family member, neighbor, friend, animal control, etc. In some alternate embodiments, controller 345 may message tracking beacon device 200 to power “on” prior to sending notifications.

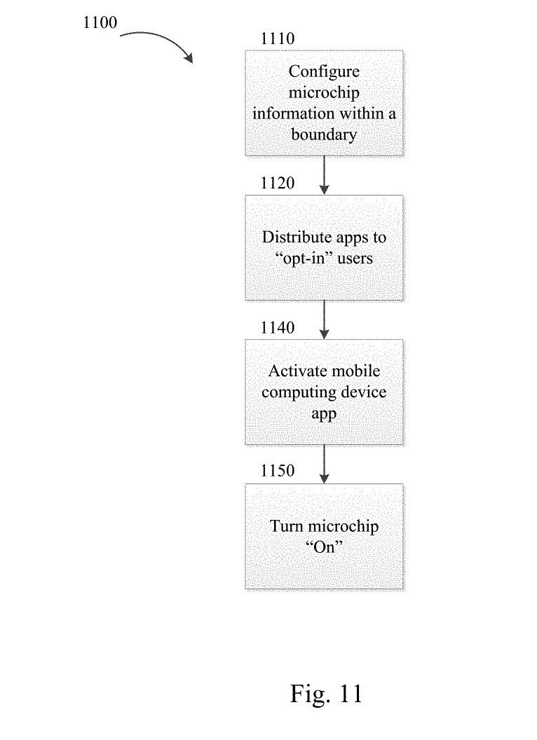

FIG. 11 illustrates an exemplary method, in accordance with an embodiment of the present invention. In the present embodiment, method 1100 may start at a step 1110 where tracking beacon device 200 may be configured for use within boundary 342. In some embodiments, firmware for tracking beacon device 200 may be updated to include for example, but not limited to, ID, contact information for the user, and operating parameters. In some embodiments, controller 345 in combination with mobile computing device 350 may be utilized to update the firmware. In a step 1120 detection software may be needed and activated in mobile computing devices in which the owners have installed apps to recognize the chirps and directly communicate to the owner's mobile computing device 350. These owners may be acting as a Good Samaritan to directly contact the owner of tracking beacon device 200 without a contract for the service. In some alternate embodiments, owners with installed apps may be able to take a picture of a lost pet and attach the picture to the notification sent to the owner of the pet. In a step 1140 a custom app may be needed on the user's mobile computing device 350. In some embodiments, the app may be needed to be activated by the user. In other alternate embodiments, the installment of the app may active the app to run in a background mode. In a step 1150 tracking beacon device 200 may be turned “On” to chirp to local system 335 when controller 345 detects that tracking beacon device 200 has left boundary 342. In some embodiments, a user 360 may be asked to respond to the notification by causing tracking beacon device 200 to power “on.” In some embodiments, if the user does not enable the device (e.g. cell phone turned off or signal unavailable), the software may contact the next notification setting such as, but not limited to, family member, neighbor, friend, animal control, etc. In some alternate embodiments, controller 345 may message tracking beacon device 200 to power “on” prior to sending notifications.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

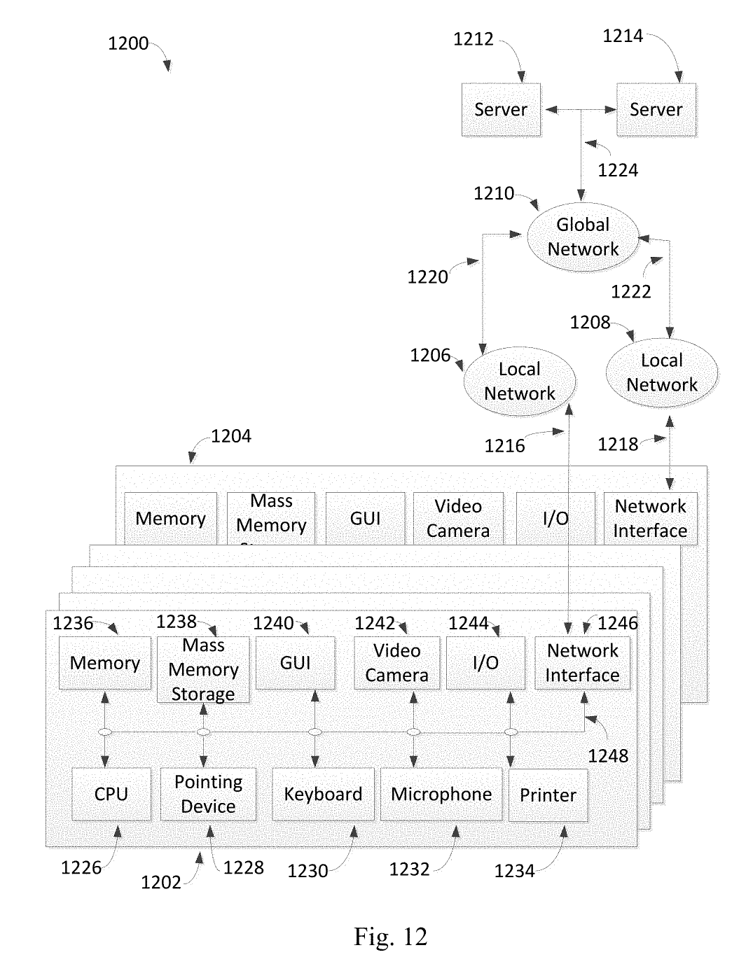

FIG. 12 is a block diagram depicting an exemplary client/server system which may be used by an exemplary web-enabled/networked embodiment of the present invention.

A communication system 1200 includes a multiplicity of clients with a sampling of clients denoted as a client 1202 and a client 1204, a multiplicity of local networks with a sampling of networks denoted as a local network 1206 and a local network 1208, a global network 1210 and a multiplicity of servers with a sampling of servers denoted as a server 1212 and a server 1214.

Client 1202 may communicate bi-directionally with local network 1206 via a communication channel 1216. Client 1204 may communicate bi-directionally with local network 1208 via a communication channel 1218. Local network 1206 may communicate bi-directionally with global network 1210 via a communication channel 1220. Local network 1208 may communicate bi-directionally with global network 1210 via a communication channel 1222. Global network 1210 may communicate bi-directionally with server 1212 and server 1214 via a communication channel 1224. Server 1212 and server 1214 may communicate bi-directionally with each other via communication channel 1224. Furthermore, clients 1202, 1204, local networks 1206, 1208, global network 1210 and servers 1212, 1214 may each communicate bi-directionally with each other.

In one embodiment, global network 1210 may operate as the Internet. It will be understood by those skilled in the art that communication system 1200 may take many different forms. Non-limiting examples of forms for communication system 1200 include local area networks (LANs), wide area networks (WANs), wired telephone networks, wireless networks, or any other network supporting data communication between respective entities.

Clients 1202 and 1204 may take many different forms. Non-limiting examples of clients 1202 and 1204 include personal computers, personal digital assistants (PDAs), cellular phones and smartphones.

Client 1202 includes a CPU 1226, a pointing device 1228, a keyboard 1230, a microphone 1232, a printer 1234, a memory 1236, a mass memory storage 1238, a GUI 1240, a video camera 1242, an input/output interface 1244 and a network interface 1246.

CPU 1226, pointing device 1228, keyboard 1230, microphone 1232, printer 1234, memory 1236, mass memory storage 1238, GUI 1240, video camera 1242, input/output interface 1244 and network interface 1246 may communicate in a unidirectional manner or a bi-directional manner with each other via a communication channel 1248. Communication channel 1248 may be configured as a single communication channel or a multiplicity of communication channels.

CPU 1226 may be comprised of a single processor or multiple processors. CPU 1226 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general-purpose microprocessors.

As is well known in the art, memory 1236 is used typically to transfer data and instructions to CPU 1226 in a bi-directional manner. Memory 1236, as discussed previously, may include any suitable computer-readable media, intended for data storage, such as those described above excluding any wired or wireless transmissions unless specifically noted. Mass memory storage 1238 may also be coupled bi-directionally to CPU 1226 and provides additional data storage capacity and may include any of the computer-readable media described above. Mass memory storage 1238 may be used to store programs, data and the like and is typically a secondary storage medium such as a hard disk. It will be appreciated that the information retained within mass memory storage 1238, may, in appropriate cases, be incorporated in standard fashion as part of memory 1236 as virtual memory.

CPU 1226 may be coupled to GUI 1240. GUI 1240 enables a user to view the operation of computer operating system and software. CPU 1226 may be coupled to pointing device 1228. Non-limiting examples of pointing device 1228 include computer mouse, trackball and touchpad. Pointing device 1228 enables a user with the capability to maneuver a computer cursor about the viewing area of GUI 1240 and select areas or features in the viewing area of GUI 1240. CPU 1226 may be coupled to keyboard 1230. Keyboard 1230 enables a user with the capability to input alphanumeric textual information to CPU 1226. CPU 1226 may be coupled to microphone 1232. Microphone 1232 enables audio produced by a user to be recorded, processed and communicated by CPU 1226. CPU 1226 may be connected to printer 1234. Printer 1234 enables a user with the capability to print information to a sheet of paper. CPU 1226 may be connected to video camera 1242. Video camera 1242 enables video produced or captured by user to be recorded, processed and communicated by CPU 1226.

CPU 1226 may also be coupled to input/output interface 1244 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 1226 optionally may be coupled to network interface 1246 which enables communication with an external device such as a database or a computer or telecommunications or internet network using an external connection shown generally as communication channel 1216, which may be implemented as a hardwired or wireless communications link using suitable conventional technologies. With such a connection, CPU 1226 might receive information from the network, or might output information to a network in the course of performing the method steps described in the teachings of the present invention.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC § 112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC § 112 (6).

It is noted that according to USA law, all claims must be set forth as a coherent, cooperating set of limitations that work in functional combination to achieve a useful result as a whole. Accordingly, for any claim having functional limitations interpreted under 35 USC § 112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC § 112 (6) is/(are) dependent on one or more remote servers located outside the USA, it is intended that each such recited function under 35 USC § 112 (6) is to be interpreted as the function of the local system receiving the remotely generated information required by a locally implemented claim limitation, wherein the structures and or steps which enable, and breathe life into the expression of such functions claimed under 35 USC § 112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC § 112 (6)” should be replaced with the closest corresponding statute in the patent laws of such pertinent country or countries or legal organization(s).

In some embodiments, a tracking beacon device according to the teaching herein, may be used to track luggage. In some embodiments, the tracking beacon device may trigger a camera inside the luggage to turn on if the luggage may be opened by TSA or a thief. In some embodiments, the tracking beacon device maybe put in a bicycle tubing. In a non-limiting example, the owner may get a signal that supposedly a parked bike may be on the move thus alerting the owner that the bike has been stolen. In some embodiments, the tracking beacon device may be sewn into wallets & purses and backpacks. In some embodiments, the tracking beacon device may be put in larger jewelry pieces like expensive watches. In some embodiments, the tracking beacon device may be used to track lost keys, a cell phone, etc. In some embodiments, the tracking beacon device may be used in cars, boats, motorcycles, etc. In a non-limiting example, the owner may be notified if a parked car is “on the move” thus alerting the owner that car has been stolen. In some embodiments, the tracking beacon device may be used in cars and may detect vibration from a broken window alerting the owner of a car theft. In some embodiments, the tracking beacon device may be used in humans. In a non-limiting example, an implanted chip in a hand may replace car keys, house keys, credit cards, etc. In some embodiments, the tracking beacon device may be give someone temporary access (e.g. housekeeper) by granting temporary permit to a housekeeper's chip. In some embodiments, the tracking beacon device may contain medical information. In a non-limiting example, every time, but not limited to, the owner visits a doctor, a hospital or any medical practitioner, (lab work, x-rays, etc.), tests and results, notes from charts, etc. may be uploaded into a central database. In a non-limiting example, the owner may walk into a doctor or be taken to a hospital unconscious and their hand may be placed under a scanner. Their, without limitation, name, address, next of kin, complete medical history, medications, all tests and results and films may be linked. Further, additional filling out of paperwork may not be required and the practitioner may have, but not limited to, a set of medical history, personal data, address and emergency contacts, DNR orders, medicines being taken, allergies to medicines, etc. Further, the database may flag contraindications of drugs being prescribed with those already taking. In a non-limiting example, a doctor may not have to call a prescription in or fax. The doctor may upload the prescription to a central database and the owner may walk into a pharmacy and waive their hand under a scanner where the pharmacy accesses the database, fills prescription and notes the database that prescription was filled. In some embodiments, the tracking beacon device may emit a small electrical impulse to a heart in a case of a heart attack. In some embodiments, the tracking beacon device may trigger other internal medical devices to deliver medication doses. In some embodiments, the tracking beacon device may trigger external medical devices to deliver doses, such as, but not limited to, oxygen. In some embodiments, the tracking beacon device may track and store or emit vitals, such as, but not limited to, blood sugar levels, etc. In some embodiments, the tracking beacon device may sound an external alarm if someone may be having a heart attack or a seizure. In a non-limiting example, an owner may have a heart attack in the middle of the night. The tracking beacon device may sound an alarm in the house alerting others. In some embodiments, the tracking beacon device may be used legally to establish a physical location as an alibi. In some embodiments, the tracking beacon device may be used to track kidnapped soldiers, kids, etc. In some embodiments, the tracking beacon device may have added sensors connected to it externally to monitor bodily functions, vitals, etc. If the collar has breakaway function, in some embodiments, the tracking beacon device may be used to track and retrieve the collar including existing GPS collars. In some embodiments, the tracking beacon device may send a signal to a collar to sound an alarm to draw people's attention to the animal. In some embodiments, the tracking beacon device may be used in conjunction with car technology to notify cars that an animal or person is approaching so the animal or person doesn't get hit.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112 (6) when such corresponding structures are not explicitly disclosed in the foregoing patent specification. Therefore, for any invention element(s)/structure(s) corresponding to functional claim limitation(s),in the below claims interpreted under 35 USC § 112 (6), which is/are not explicitly disclosed in the foregoing patent specification, yet do exist in the patent and/or non-patent documents found during the course of USPTO searching, Applicant(s)incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing location tracking according to the present invention will be apparent to those skilled in the art. Various aspects of the invention have been described above by way of illustration, and the specific embodiments disclosed are not intended to limit the invention to the particular forms disclosed. The particular implementation of the location tracking may vary depending upon the particular context or application. By way of example, and not limitation, the location tracking described in the foregoing were principally directed to methods for using biocompatible tracking devices implementations; however, similar techniques may instead be applied to tracking of inanimate objects, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

What is claimed is:

1. A method comprising the steps of:
configuring a tracking beacon device for at least associating the tracking beacon device to an entity to be tracked and an owner of the tracking beacon device;
detecting the tracking beacon has at least departed a determined boundary;
notifying at least one person, comprising the owner, of said detection, the at least one person notifying at least one cell phone service provider to monitor at least one signal broadcasted by the tracking beacon and activating a computing device application to receive a communication from the cell phone service provider, the communication at least comprising a location for the signal; and
activating the tracking beacon to broadcast the signal.

2. The method as recited in claim 1, in which the tracking beacon device is joined to the entity.

3. The method as recited in claim 1, in which said detecting at least comprises a virtual fence.

4. The method as recited in claim 1, in which the cell phone service provider uses more than one receiving tower to monitor the signal.

5. The method as recited in claim 1, in which the broadcasted signal comprises a chirp.

6. The method as recited in claim 1, in which the tracking beacon device is implantable within the entity.

7. The method as recited in claim 1, in which the tracking beacon device at least comprises a rechargeable power supply.

8. The method as recited in claim 7, in which the rechargeable power supply is charged by an external collar.

9. The method as recited in claim 1, in which the entity comprises a pet.

10. A tracking system comprising:
a boundary sensor system; and,
a tracking beacon device that is at least partially implanted into an entity to be tracked, comprising:
a power module that is at least partially implanted into an entity to be tracked;
a transceiver module that is at least partially implanted into an entity to be tracked;
an identification module that is at least partially implanted into an entity to be tracked, said identification module being configured to provide a unique identification of the entity to be tracked; and
a controller module that is at least partially implanted into an entity to be tracked, wherein said controller module is at least configured to activate said transceiver module to transmit a tracking signal when said tracking beacon device goes beyond a boundary limit set by said boundary sensor system.

11. The tracking system comprising of claim 10, wherein said power module comprises a means for generating power.

12. The tracking system comprising of claim 10, wherein said power module comprises a means for storing power.

13. The tracking system comprising of claim 10, wherein said power module comprises a means for generating power.

14. The tracking system comprising of claim 10, wherein said identification module and said transceiver module are configured with means for communicating an informational distress message to a nearby 3^{rd} party system to help tracking of said tracking beacon device.

15. A tracking system comprising:
means for powering a tracking beacon device of said tracking system;
means for identifying an entity to be tracked;
means for at least associating said identifier means to the entity to be tracked and an owner of the tracking beacon device;
means for detecting that the tracking beacon device has at least departed a determined boundary;
means for notifying at least one person, comprising the owner, that a detection event was generated by said detection means;
means for detecting at least a general location of said tracked entity; and
means for transmitting and receiving communications from a third party service provider, the communications at least comprising some general location information provided by said location detection means.

16. A method comprising:
steps for configuring a tracking beacon device;
steps for detecting the tracking beacon has departed a boundary;
steps for activating the tracking beacon to broadcast the signal;
steps for notifying a monitoring system that the tracking beacon device has departed a boundary;
steps for determining at least a general location of said tracking beacon device after it has departed the boundary; and
steps for communicating said general location of said tracking beacon device to an entity associated with said tracking beacon device.
